(19) United States
(12) Patent Application Publication
(10) Pub. No.: US 2009/0297109 A1
(43) Pub. Date: Dec. 3, 2009

(54) Optical Fiber End Structure

(76) Inventor: DeJian Li, Guangdong (CN)

Correspondence Address: DAVID AND RAYMOND PATENT FIRM, 108 N. YNEZ AVE., SUITE 128, MONTEREY PARK, CA, 91754, US

(21) Appl. No.: 11/883,111

(22) PCT Filed: Apr. 5, 2006
(86) PCT No.: PCT/CN06/00606

§ 371 Date: Jul. 25, 2007

(51) Int. Cl. G02B 6/036

(52) U.S. Cl. 385/128

(57) ABSTRACT

An optical fiber end structure includes an optical fiber having a core end portion and a coating portion extending therefrom, and a glass capillary having a pore. The core end portion of the optical fiber is extended within the pore of the glass capillary. An outer surface of the core end portion of the optical fiber is heat-melted with an inner surface of the pore of the glass capillary to form a transitional layer therebetween such that the core end portion of the optical fiber is coaxially aligned along the axis of the glass capillary. Therefore, it significantly reduces the deviation distance between the core end portion of the optical fiber and the pore of the glass capillary. It not only increases the glass capillary stability and reliability, lower the manufacturing cost, but also improves manufacturing quality and its precision.

### BACKGROUND OF THE PRESENT INVENTION

1. Field of Invention

The present invention relates to an optical fiber, and more particularly to an optical fiber end structure to minimize the deviation of the core end portion of the optical fiber with respect to the glass capillary.

2. Description of Related Arts

An optical fiber for a conventional optical fiber end connector is made of ceramic. Likewise, the optical fiber for a conventional optical fiber collimator or other optoelectronic device is made of glass capillary. Accordingly, either the tube capillary is made of the ceramic or glass, a predetermined size of the optical fiber must be configured with respect to the tube capillary so as to couple the optical fiber with the tube capillary. Generally speaking, a conventional technology for manufacturing fiber capillary includes an initial step of injecting an organic adhesive 3 into a pore of the tube capillary 2. As shown in FIGS. 1 and 2, a core of the optical fiber is then inserted into the pore of the tube capillary 2. Finally, after the optical fiber is adhered to the inner surface of the core of the tube capillary 2 by solidifying the adhesive, the fiber capillary is formed. However, such conventional manufacturing process has several drawbacks.

1. The dimension of the pore of the tube capillary must be extremely precise that the deviation between the actual value of the inner diameter of the pore and the criterion value thereof must be extremely small. Accordingly, the tolerable deviation between the criterion value and the actual value is 1 μm and the tolerable deviation between the criterion value and the actual value of the outer diameter is 5 μm. The tolerable deviation between the axis of the single-core capillary and the pore is 5 μm. Because the accuracy requirement for all the material is extremely high, the manufacturing cost to produce all different kinds of capillary is respectively expensive.

2. The optical fiber cannot be precisely located at the same position or at the center of the core. In other words, even though the optical fiber and the tube capillary are precisely formed to minimize the tolerable deviation between the criterion value and the actual value at 1 μm, there is still a clearance formed between the inner surface of the pore and the optical fiber.

3. In the procedure of solidifying the adhesive, the volume of the adhesive between the capillary and the fiber is dramatically changed. The fiber finally bends or displaces its position owing to volume change of adhesive. In other words, the optical fiber within the pore cannot be controlled during the solidification of the adhesive. Since it cannot be controlled the degree of bending and displacement of the optical fiber, the quality of the final product such as the optical fiber end connector is unstable and inconstancy.

4. No matter which type of fiber capillary is needed to produce, the process requires bonding the optical fiber, organic adhesive, and tube capillary together. Accordingly, the current optical fiber is made of quartz glass. The hardness for quartz is far greater than the organic adhesive and tube capillary. In the process of manufacturing, especially in grinding process, those three different materials are completely different in its nature. It not only increases the difficulty of manufacturing, but also increasing the manufacturing cost. Furthermore, because of viscosity, yield, and elastic deformation in organic adhesive, it makes the fiber waving or displacement inside the pore. It further increases the difficulty of manufacturing and cost.

5. Beside mechanical properties, the temperature characteristic among the organic adhesive, the optical fiber and the tube capillary are different. The organic adhesive expanding or contracting from temperature change leads to bend and displace its position. It dramatically damages the continuation and performance. Furthermore the organic adhesive has strong absorbent. The more water the organic adhesive absorbing from air, the more volume it expands. Finally, the expansion of the organic adhesive makes the optical fiber unintentionally bending and displacement inside the pore. It decreases the life span of the equipment.

### SUMMARY OF THE PRESENT INVENTION

A main object of present invention is to provide an optical fiber end structure which has a simple structural configuration, a simplified manufacturing process, a relatively low manufacturing cost, and an adhesive free configuration.

Accordingly, the present invention provides an optical fiber end structure comprising an optical fiber having a core end portion and a coating portion extending therefrom, and a glass capillary having at least a pore, wherein the core end portion of the optical fiber is inserted into the pore of the glass capillary, wherein an outer surface of the core end portion of the optical fiber is heat-bonded with an inner surface of the pore of the glass capillary to form a transitional layer therebetween.

When the glass capillary contains two or more pores, two or more optical fibers can be coupled to the glass capillary by inserting the core end portions of the optical fibers into the pores such that the outer surfaces of the core end portions of the optical fibers are heat-bonded with the inner surfaces the pores of glass capillary respectively.

Accordingly, the glass capillary comprises two or more tubular layers coaxially coupling with each other.

The present invention provides the optical fiber end structure to couple the core end portion of the optical fiber with the glass capillary, wherein the glass capillary is heat-melted with the core end portion of the optical fiber such that the outer surface of the core end portion of the optical fiber is perfectly coupled with the inner surface the pore of glass capillary so as to precisely locate the core end portion of the optical fiber at a center of the glass capillary. Since the deviation of the core end portion of the optical fiber with respect to the glass capillary is minimized, it will increase the stabilization of the connection and prolong its life span of the optical fiber end structure. In addition, the transitional layer is formed between the outer surface of the core end portion of the optical fiber and the inner surface the pore of glass capillary instead of the organic adhesive, the transitional layer can effectively enhance the absorption and spread the pressure between the optical fiber and the glass capillary so as to increase the stability and reliability thereof. Thus, the structure will lower the manufacturing cost and improve manufacturing quality and its precision.

It is worth to mention that the optical fiber end structure of the present invention can be used for single-core, double-core, quad-core, or multi-core optical fabric fabrication.

### BRIEF DESCRIPTION OF THE DRAWINGS

FIG. 1 is a schematic view illustrating the conventional optical fiber end structure.

FIG. 2 is a sectional view illustrating the conventional optical fiber end structure.

FIG. 3 is a schematic view of an optical fiber end structure according to a preferred embodiment of the present invention.

FIG. 4 is a side-sectional view of the optical fiber end structure according to the above preferred embodiment of the present invention.

FIG. 5 is a front-sectional view of the optical fiber end structure according to the above preferred embodiment of the present invention.

FIG. 6 illustrates the optical fiber end structure with multi-core according to the above preferred embodiment of the present invention.

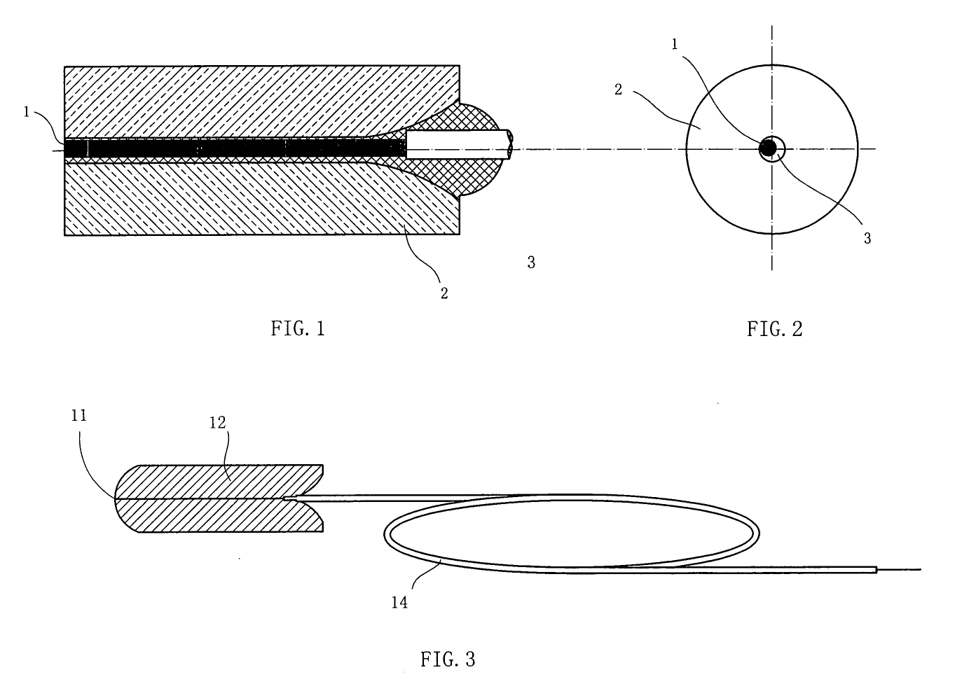

### DETAILED DESCRIPTION OF THE PREFERRED EMBODIMENT

Referring to FIGS. 3 to 5 of the drawings, an optical fiber end structure according to a preferred embodiment is illustrated.

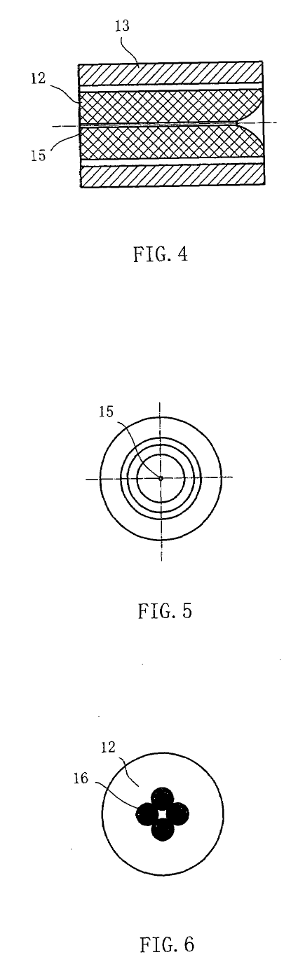

As shown in FIGS. 3 and 4, the optical fiber end structure comprises a predetermined length of an optical fiber having a core end portion 11 and a coating portion 14 extending therefrom, and a glass capillary 12 having at least a pore 15, wherein the core end portion 11 of the optical fiber is extended within the pore 15 of the glass capillary 12, wherein an outer surface of the core end portion 11 of the optical fiber is heat-bonded with an inner surface the pore 15 of the glass capillary 12 to form a transitional layer therebetween. Accordingly, the glass capillary 12 is heat-melted with the core end portion 11 of the optical fiber in a conceal manner such that the outer surface of the core end portion 11 of the optical fiber is perfectly coupled with the inner surface the pore 15 of glass capillary 12 so as to precisely locate the core end portion 11 of the optical fiber at a center of the glass capillary 12. Due to the different temperatures between the outer surface of the core end portion 11 of the optical fiber and the inner surface the pore 15 of glass capillary 12, a stress is created between the outer surface of the core end portion 11 of the optical fiber and the inner surface the pore 15 of glass capillary 12 after the temperature drops from the heat-bond state to the normal room temperature. During the heat-bond process, the ions are expanding between the outer surface of the core end portion 11 of the optical fiber and the inner surface the pore 15 of glass capillary 12 to form the transitional layer. It is worth to mention that the transitional layer substantially minimizes the clearance between the outer surface of the core end portion 11 of the optical fiber and the inner surface the pore 15 of glass capillary 12. In other words, there is no obvious connection interface between the outer surface of the core end portion 11 of the optical fiber and the inner surface the pore 15 of glass capillary 12 by dispensing the stress therebetween. Therefore, the core end portion 11 of the optical fiber can be substantially coupled with the glass capillary 12 at a position that the core end portion 11 of the optical fiber is coaxially aligned along the axis of the glass capillary 12. Accordingly, unless the environmental temperature of the optoelectronic device is above the temperature of softening point of the glass capillary 12, the core end portion 11 of the optical fiber is coaxially aligned along the axis of the glass capillary 12 under any condition. Therefore, the structural configuration enhances the stability and reliability of the optical fiber end structure for light guide, especially the optical fiber end structure being used for the optical fiber end connector.

As shown in FIGS. 5 and 6, alternative mode of the optical fiber end structure is illustrated, which has the same structural configuration of the preferred embodiment. As it is mentioned above, the core end portion 11 of the optical fiber is coupled with the glass capillary 12 to form a single core structure. Alternatively, the glass capillary 12 contains two or more pores 16 for coupling with core end portions 16 of two or more optical fibers respectively such that the outer surfaces of the core end portions 11 of the optical fibers are heat-bonded with the inner surfaces the pores 16 of glass capillary 12 to form a double-core structure, quad-core structure, or multi-core structure. In addition, the glass capillary 12 comprises two or more tubular layers coaxially and overlappedly coupling with each other, wherein the pore 15 is formed at the center of the glass capillary 12.

What is claimed is:

1. An optical fiber end structure, comprising an optical fiber having a core end portion and a coating portion extending therefrom, and a glass capillary having a pore, wherein said core end portion of said optical fiber is extended within said pore of said glass capillary, wherein an outer surface of said core end portion of said optical fiber is heat-bonded with an inner surface of said pore of said glass capillary to form a transitional layer therebetween.

2. An optical fiber end structure, comprising two or more optical fibers each having a core end portion and a coating portion extending therefrom, and a glass capillary having two or more pores, wherein said core end portions of said optical fibers are extended within said pores of said glass capillary respectively, wherein an outer surface of said core end portion of each of said optical fibers is heat-bonded with an inner surface of each of said pores of said glass capillary to form a transitional layer therebetween.

3. The optical fiber end structure, as recited in claim 1, wherein said glass capillary comprises two or more tubular layers coaxially and overlappedly coupling with each other.
